(19) United States
(12) Patent Application Publication
(10) Pub. No.: US 2022/0398097 A1
(43) Pub. Date: Dec. 15, 2022

(54) INTERACTIVE AND CORPORATION-WIDE WORK ANALYTICS OVERVIEW SYSTEM

(71) Applicant: ADOBE INC., SAN JOSE, CA (US)

(72) Inventors: Kevin Smith, Lehi, UT (US); William Brandon George, Pleasant Grove, UT (US)

(21) Appl. No.: 17/347,127

(22) Filed: Jun. 14, 2021

(51) Int. Cl. G06F 8/77; G06F 16/25; G06Q 10/06

(52) U.S. Cl. CPC G06F 8/77; G06F 16/258; G06Q 10/0633; G06Q 10/06313

(57) ABSTRACT

Systems and methods for software management are described. One or more embodiments of the present disclosure receive first event data from a first software system and second event data from a second software system, wherein the first event data is formatted using a first data format and the second event data is formatted using a second data format, generate first converted event data and second converted event data by converting the first event data and the second event data to a common data format, generate combined time series data by combining the first converted event data and the second converted event data, compute attribution information indicating a causal relationship between a first metric from the first software system and a second metric from the second software system based on the combined time series data, signal the attribution information indicating the relationship between the first metric and the second metric.

### BACKGROUND

The following relates generally to software management, and more specifically to management of multiple software systems.

Software management systems are systems that monitor and administer software systems. For example, software management systems can be used for discovering useful information, collecting information, and informing conclusions. In some cases, departments within a corporation can use software systems to perform tasks such as project management and customer relationship management. For example, project management tasks may be performed using software systems for planning, scheduling, resource allocation, execution, tracking, and delivery of projects.

However, the systems used by different departments within a company may not be compatible. For example, the data models used by project management software may be incompatible with systems used for customer relationship management (e.g., because they track different things, receive input data having different data format, and are used for different purposes). Conventional software management systems fail to integrate these different systems, and are therefore incapable of providing cross-department data analytics for different kinds of metrics. Therefore, there is a need in the art for improved software management systems that can provide data analytics across multiple software systems.

### SUMMARY

The present disclosure describes systems and methods for software management. Some embodiments of the disclosure include a software management apparatus configured to convert event data from multiple different software systems to a common data format. The software management apparatus can be used to compute attribution information and segmentation information. In some examples, attribution information indicates a causal relationship between a first metric from a first software system and a second metric from a second software system based on a combined time series data. Segmentation information indicates a set of data groups based on the combined time series data.

A method, apparatus, and non-transitory computer readable medium for software management are described. One or more embodiments of the method, apparatus, and non-transitory computer readable medium include receiving first event data from a first software system and second event data from a second software system, wherein the first event data is formatted using a first data format and the second event data is formatted using a second data format, generating first converted event data and second converted event data by converting the first event data and the second event data to a common data format, generating combined time series data by combining the first converted event data and the second converted event data, computing attribution information indicating a causal relationship between a first metric from the first software system and a second metric from the second software system based on the combined time series data, and signaling the attribution information indicating the relationship between the first metric and the second metric.

A method, apparatus, and non-transitory computer readable medium for software management are described. One or more embodiments of the method, apparatus, and non-transitory computer readable medium include receiving first event data from a first software system and second event data from a second software system, wherein the first event data is formatted using a first data format and the second event data is formatted using a second data format, generating first converted event data and second converted event data by converting the first event data and the second event data to a common data format, generating combined time series data by combining the first converted event data and the second converted event data, computing segmentation information indicating a plurality of data groups based on the combined time series data, and signaling the segmentation information indicating the plurality of data groups.

An apparatus and method for software management are described. One or more embodiments of the apparatus and method include a first software system configured to generate first event data formatted using a first data format, a second software system configured to generate second event data formatted using a second data format, a data conversion component configured to generate first converted event data and second converted event data by converting the first event data and the second event data to a common data format, a data combining component configured to generate combined time series data by combining the first converted event data and the second converted event data, and an attribution component configured to compute attribution information indicating a causal relationship between a first metric from the first software system and a second metric from the second software system based on the combined time series data.

A method, apparatus, and non-transitory computer readable medium for software management are described. One or more embodiments of the method, apparatus, and non-transitory computer readable medium include receiving first event data from a first software system used by a first organizational unit and second event data from a second software system used by a second organizational unit, wherein the first event data is formatted using a first data format and the second event data is formatted using a second data format, generating first converted event data and second converted event data by converting the first event data and the second event data to a common data format, generating a model for predicting an organizational metric based on the first converted event data and the second converted event data, receiving a candidate resource allocation that includes resources for the first organizational unit and the second organizational unit, and predicting an outcome for the first metric based on the model and the candidate resource allocation.

### BRIEF DESCRIPTION OF THE DRAWINGS

FIG. 1 shows an example of a software management system according to aspects of the present disclosure.

FIG. 2 shows an example of a process for software management according to aspects of the present disclosure.

FIG. 3 shows an example of a workflow process in a department according to aspects of the present disclosure.

FIGS. 4 and 5 show examples of a software management apparatus according to aspects of the present disclosure.

FIG. 6 shows an example of a process for computing attribution information according to aspects of the present disclosure.

FIG. 7 shows an example of a process of computing segmentation information according to aspects of the present disclosure.

### DETAILED DESCRIPTION

The present disclosure describes systems and methods for software management. Some embodiments of the disclosure include a software management apparatus configured to enable a comprehensive understanding and an analytical view of work progress within an organization. An example software management apparatus is configured to convert event data from multiple different software systems to a common data format. The converted data can be used to compute attribution information and segmentation information. In some examples, attribution information indicates a causal relationship between a first metric from a first software system and a second metric from a second software system based on a combined time series data. Segmentation information indicates a set of data groups based on the combined time series data.

Project management systems and other software systems are widely used to plan, schedule sequential activities, manage resources, and track workflow in business organizations. However, different departments within an organization use different software systems for various types of task management, monitoring and reporting. As a result, work progress is tracked at the department-level rather than at the organizational level. For example, an engineering department may use issue tracking software for tracking and reporting while marketing department adopts a different software, using a distinct data format, for managing a marketing budget.

Conventional software management systems fail to provide meaningful information about the interaction of events in different departments that are tracked using different kinds of software. For example, the systems do not provide insight into the influence of tasks in early stages of a workflow on tasks in subsequent stages of a workflow. Furthermore, the systems do not evaluate the effect of a task or decision in one department on the entire organization. As a result, those in positions of leadership have a hard time understanding the effect of one department of the organization on another department.

Embodiments of the present disclosure receive event data from multiple different software systems and normalize the event data into a common data format for subsequent evaluation. In some embodiments, a software management apparatus is configured to compute segmentation information, attribution information, and perform anomaly detection so that users can understand an overall workflow view in an organization. In some examples, the software management apparatus is configured to determine the effect of a task or decision in one department on the entire organization. In some examples, a dynamic and analytical user interface (UI) enables users such as business executives to understand the effect of changes in resources or the effect of a task scheduled in one department on the entire organization.

According to an embodiment, users may view the workflow or work progress from an organization level and view the effect of one task on different parts of the organization using the software management apparatus. Any work and the associated attributes and metadata are tracked and recorded for subsequent information retrieval. For example, a search query is input to the software management apparatus via the user interface to filter, aggregate and display results in real-time.

In the present disclosure, the term “metric” refers to a property, a type or an attribute of information. In some examples, metrics include number of requests (tasks) at each state, number of resources (headcount) at each state, number of person-hours spent on the current requests at each state, and number of blocked tasks at each state. Additionally, request velocity at each state (or overall) above or below benchmarks or goals at each state (or overall), trends over time (compared to last year). Metrics may also include custom calculations of customer or employee satisfaction, bottlenecks, innovation scores, etc. However, embodiments of the present disclosure are not limited to above-mentioned examples of metrics.

The term “event data” refers to actions, events, phases, or other data that is tracked by a software system that can be associated with a point or range in time. In some cases, event data includes metrics, which represent values that measure a quantity associated with the event data such as cost, man-hours, priority, complexity, or other values that can be measured quantitatively.

The term “time series data” refers so event data that is combined into a format where the time associated with the event data is comparable to the time associated with other events (e.g., where events are associated with a timeline). In some examples, the values for a given metric correspond to an extended period of time, and in some other examples the values are associated with a particular point in time. According to an embodiment of the present disclosure, time series data collected for a variety of metrics (i.e., a first converted event data, a second converted event data) may be combined to form combined time series data.

The term “data format” refers to a schema for representing event data. The format may include data fields that represent the type of event, a point or range of time associated with an event, people associated with the event, and other metrics such as cost or value.

The term “common data format” refers to a data format that represents information from one or more source data formats. In some cases, the common data format includes fields that map to one or more fields from the source data formats. For example, the common data format may have a field with a different identifier (e.g., Last Name) that corresponds to a field in a source data format with a different identifier (e.g., Family Name). In some cases, the common data format does not include fields that are included in one or more source formats. In some cases, the common data format includes fields that can be programmatically determined from one or more fields in a source data format (e.g., a “Average Amount” field can be determined by averaging multiple different amount fields).

The term “attribution information” refers to the information that identifies a relationship between two or more metrics. For example, attribution information can represent a causal relationship between metrics. In some examples, when event data is serialized in a common data format across multiple software systems, users can execute analytical queries against the software management system to view attribution information (e.g., attribution information shows whether metric A influences metric B).

The term “segmentation information” refers to information that provides clusters or groups of related data from a set of event data. For example, customers can be segmented into different customer types, software issues can be segmented according to source, complexity, priority, etc. In some cases, the segmentation information relates event data according to non-causal relationships. In some examples, when data is serialized in a common data format across multiple input systems, users can execute analytical queries against the software management system with segmentation commands Segmentation information references any property in the normalized schema, which may contain data across multiple input systems. Segmentation information may be grouped using Boolean logic operators as well as sequential logic operators.

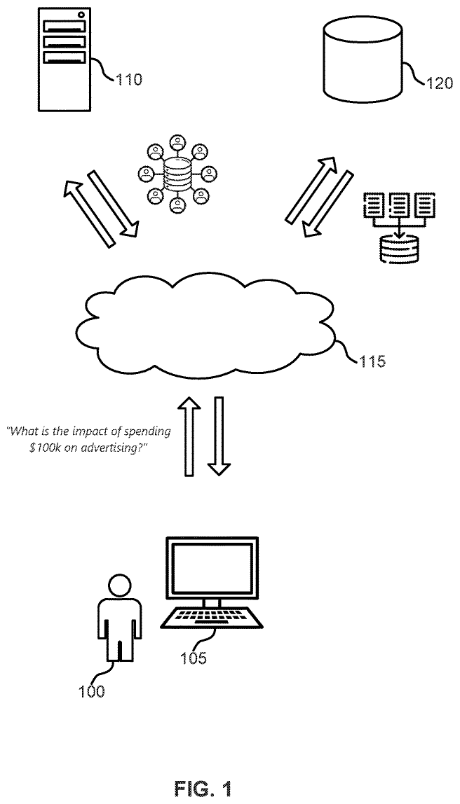

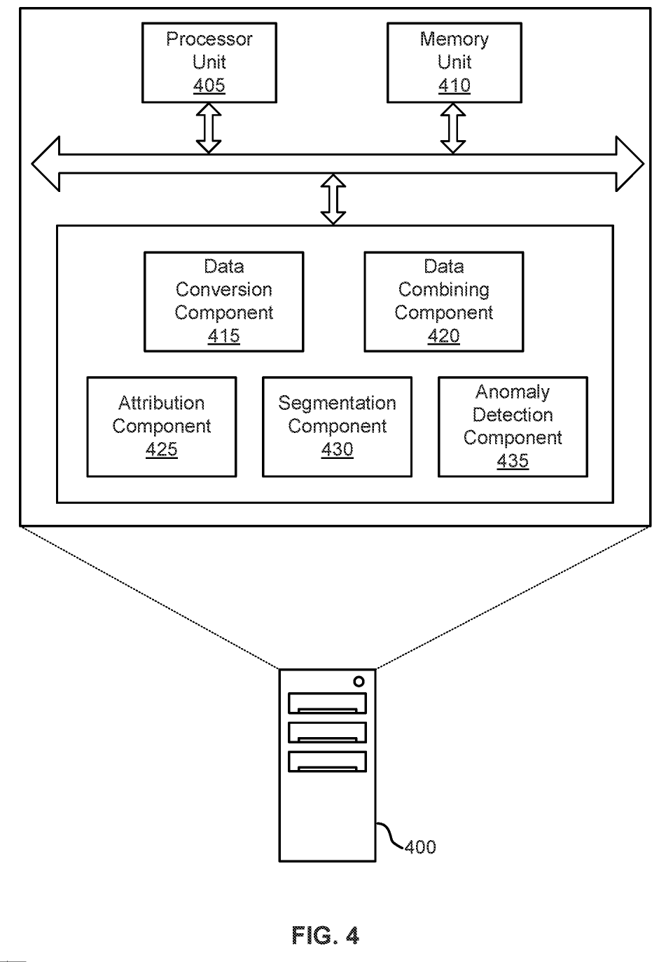

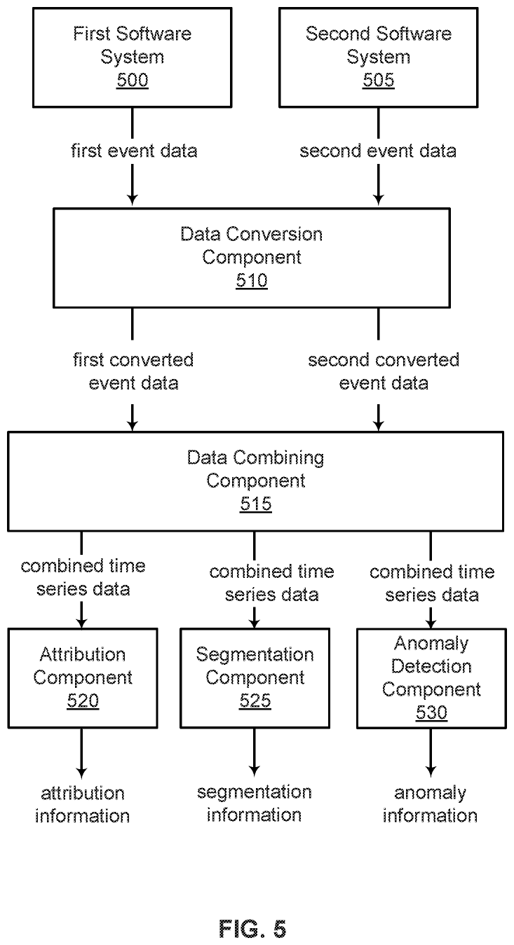

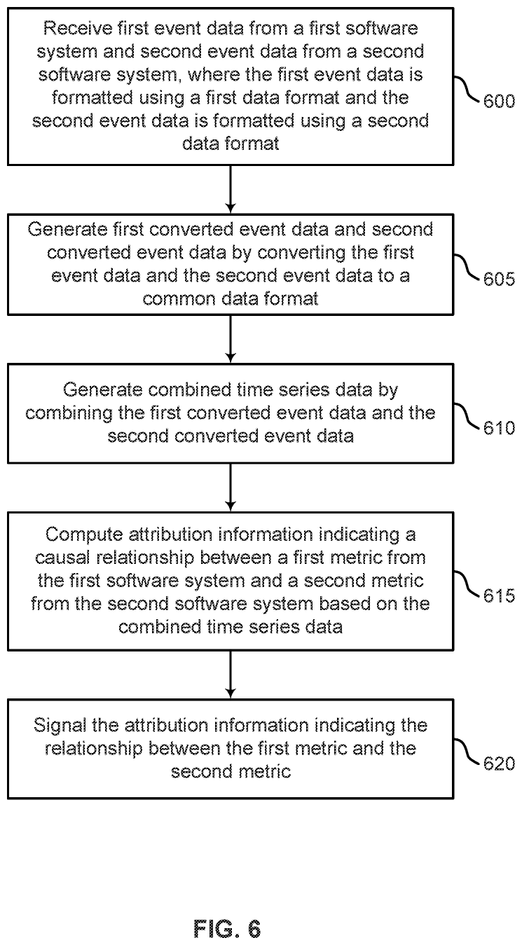

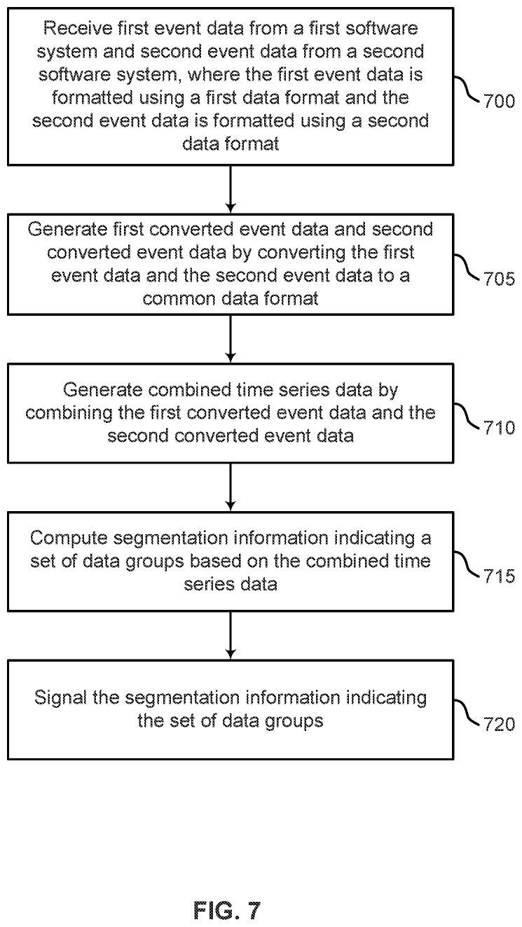

Embodiments of the present disclosure may be used in the context of project management. For example, a software management system based on the present disclosure may be used to integrate and normalize data coming from multiple different software systems to produce combined time series data. Subsequently, the software management system computes attribution and segmentation information enabling work analytics overview on organization level. An example application in the project management context is provided with reference to FIGS. 1-3. Details regarding the architecture of an example software management apparatus are provided with reference to FIGS. 4-5. An example of a process for computing attribution information is provided with reference to FIG. 6. An example of a process for computing segmentation information is provided with reference to FIG. 7.

### Software Management System

FIG. 1 shows an example of a software management system according to aspects of the present disclosure. The example shown includes user 100, user device 105, software management apparatus 110, cloud 115, and database 120.

In the example of FIG. 1, first event data from a first software system and second event data from a second software system may be stored in database 120. The first event data is formatted using a first data format while the second event data is formatted using a second data format. Software management apparatus 110 can communicate with database 120 and retrieve the stored event data. Software management apparatus 110 generates first converted event data and second converted event data by converting the first event data and the second event data to a common data format.

Software management apparatus 110 generates combined time series data by combining the first converted event data and the second converted event data. Subsequently, software management apparatus 110 computes attribution information and segmentation information. In some cases, attribution information indicates a relationship between a first metric from the first software system and a second metric from the second software system based on the combined time series data. Segmentation information indicates a set of data groups based on the combined time series data.

The user 100 communicates with the software management apparatus 110 via the user device 105 and the cloud 115. For example, the user 100 may query software management apparatus 110 to display attribution or segmentation information that the user 100 is interested. As an example, the user 100 is a business executive and is interested in knowing the effect of spending 100,000 in advertising on the entirety of a company (i.e., effect of a task from marketing department on the company as a whole). The user device 105 transmits the query to software management apparatus 110, which filters the information. In some examples, a user interface may be implemented on user device 105.

A user interface may enable a user 100 to interact with a device. In some embodiments, the user interface may include an audio device, such as an external speaker system, an external display device such as a display screen, or an input device (e.g., remote control device interfaced with the user interface directly or through an IO controller module). In some cases, a user interface may be a graphical user interface (GUI).

The user device 105 may be a personal computer, laptop computer, mainframe computer, palmtop computer, personal assistant, mobile device, or any other suitable processing apparatus. In some examples, the user device 105 includes software that incorporates a software management application. The software management application may either include or communicate with the software management apparatus 110. Alternatively or additionally, the user device 105 includes a user interface so that a user 100 can upload a query and/or view information via the user interface.

Software management apparatus 110 comprises a data conversion component, a data combining component, an attribution component, a segmentation component, and an anomaly detection component. A first software system generates first event data formatted using a first data format. A second software system generates second event data formatted using a second data format. Software management apparatus 110 generates first converted event data and second converted event data by converting the first event data and the second event data to a common data format. Software management apparatus 110 generates combined time series data by combining the first converted event data and the second converted event data. Software management apparatus 110 computes attribution information indicating a causal relationship between a first metric from the first software system and a second metric from the second software system based on the combined time series data. Additionally or alternatively, software management apparatus 110 computes segmentation information based on the combined time series data. Software management apparatus 110 identifies an anomaly in the first metric based on the combined time series data.

According to some embodiments, software management apparatus 110 receives first event data from a first software system and second event data from a second software system, where the first event data is formatted using a first data format and the second event data is formatted using a second data format. In some examples, software management apparatus 110 signals the attribution information indicating the relationship between the first metric and the second metric. In some examples, software management apparatus 110 signals the segmentation information indicating the set of data groups. Software management apparatus 110 is an example of, or includes aspects of, the corresponding element described with reference to FIG. 4.

Software management apparatus 110 may also include a processor unit and a memory unit. Additionally, software management apparatus 110 can communicate with the database 120 via the cloud 115. Further detail regarding the architecture of software management apparatus 110 is provided with reference to FIGS. 4-5. Further detail regarding a process for computing attribution information is provided with reference to FIG. 6. Further detail regarding a process for computing segmentation information is provided with reference to FIG. 7.

In some cases, software management apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a supercomputer, or any other suitable processing apparatus.

A cloud 115 is a computer network configured to provide on-demand availability of computer system resources, such as data storage and computing power. In some examples, the cloud 115 provides resources without active management by the user. The term cloud 115 is sometimes used to describe data centers available to many users over the Internet. Some large cloud networks have functions distributed over multiple locations from central servers. A server is designated an edge server if it has a direct or close connection to a user. In some cases, a cloud 115 is limited to a single organization. In other examples, the cloud is available to many organizations. In one example, a cloud includes a multi-layer communications network comprising multiple edge routers and core routers. In another example, a cloud is based on a local collection of switches in a single physical location.

A database 120 is an organized collection of data. For example, a database 120 stores data in a specified format known as a schema. A database 120 may be structured as a single database, a distributed database, multiple distributed databases, or an emergency backup database. In some cases, a database controller may manage data storage and processing in a database. In some cases, a user interacts with database controller. In other cases, database controller may operate automatically without user interaction.

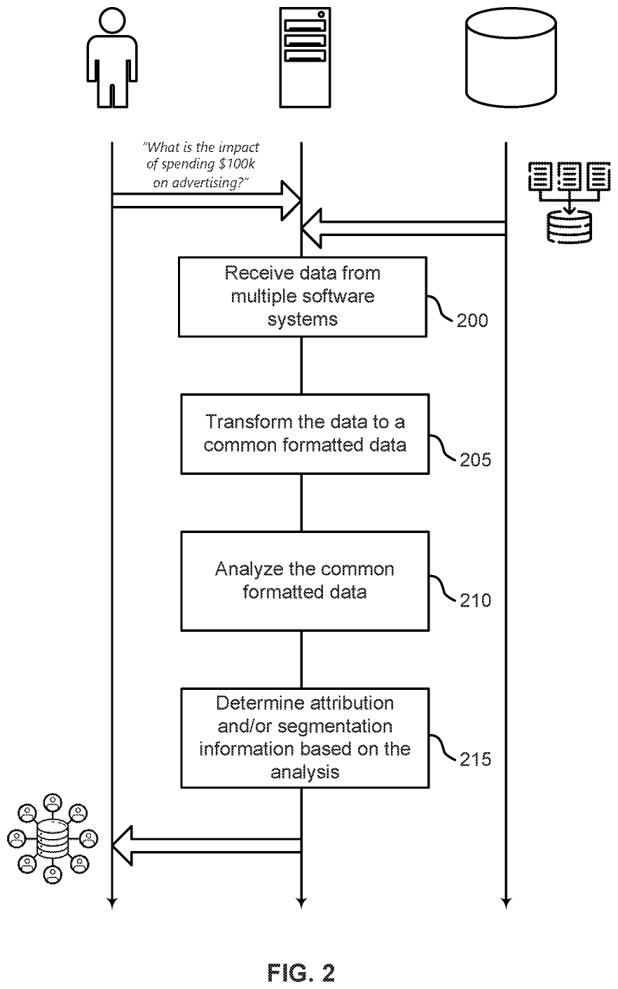

FIG. 2 shows an example of a process for software management according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 200, the system receives data from multiple software systems. In some cases, the operations of this step refer to, or may be performed by, a software management apparatus as described with reference to FIGS. 1 and 4.

The system receives data regarding task management and reporting from multiple departments of an organization. In some cases, departments use different project management systems, for example, the engineering department uses a project management software (e.g., Jira) to track and report workflow while the accounting department adopts a different software system. Software systems can be varied and disconnected in the same organization. Unlike existing technology, the software management system herein automates and streamlines the work performed within a company, for example, executive brainstorms, budgeting, design, implementation and measurement across the departments and divisions of the company. Accordingly, the system receives data from different departments of the company.

At operation 205, the system transforms the data to a common formatted data. In some examples, a normalization layer of the system is used to convert event data to a common data format. In some cases, the operations of this step refer to, or may be performed by, a software management apparatus as described with reference to FIGS. 1 and 4.

At operation 210, the system analyzes the common formatted data. In some cases, the operations of this step refer to, or may be performed by, a software management apparatus as described with reference to FIGS. 1 and 4.

The system receives event data coming from multiple different software systems that would be normalized into a common data format. The user creates a data schema that indicates a list of properties that may be populated (some may be required; some may be optional). Each property is associated with a data type as well (e.g., string, integer). Each event (which contains multiple properties itself) from each software system is then mapped into these properties of the final normalized data schema. In some examples, an optional list of rules is applied on a per-system basis, which perform small extract-transform-load (ETL) operations, as well as any property name mapping conversions. Any non-relevant property from the incoming event that is not serialized into the normalized schema would be discarded.

At operation 215, the system determines attribution and/or segmentation information based on the analysis. In some cases, the operations of this step refer to, or may be performed by, a software management apparatus as described with reference to FIGS. 1 and 4.

In some examples, the system displays a comprehensive overview, i.e., reports or user interface at a company level (top of the management hierarchy). The system integrates multiple software systems such as systems previously designed for customer journeys, measurement, and reporting. Additionally, the system measures work as it moves forward. The system computes attribution information that indicates how tasks in early stages of the workflow influence, transform, and become tasks in the later stages. For example, existing software management systems do not report on how budgeting decisions directly impact the actual tasks and work is done. Similarly, the complete workflow has unfinished tasks which impact company-level decisions. The system enables users from departments to understand the impact of departmental decisions and actions on the entire company. For example, the system may be used to evaluate if the number of patent applications filed result in increased innovation in engineering (as a cause or an effect). Similarly, the system may also be used to evaluate the impact of decisions in executive meetings and budgeting on the number of patent applications filed. The organization may dedicate resources to the in-house legal department based on such attribution and segmentation information.

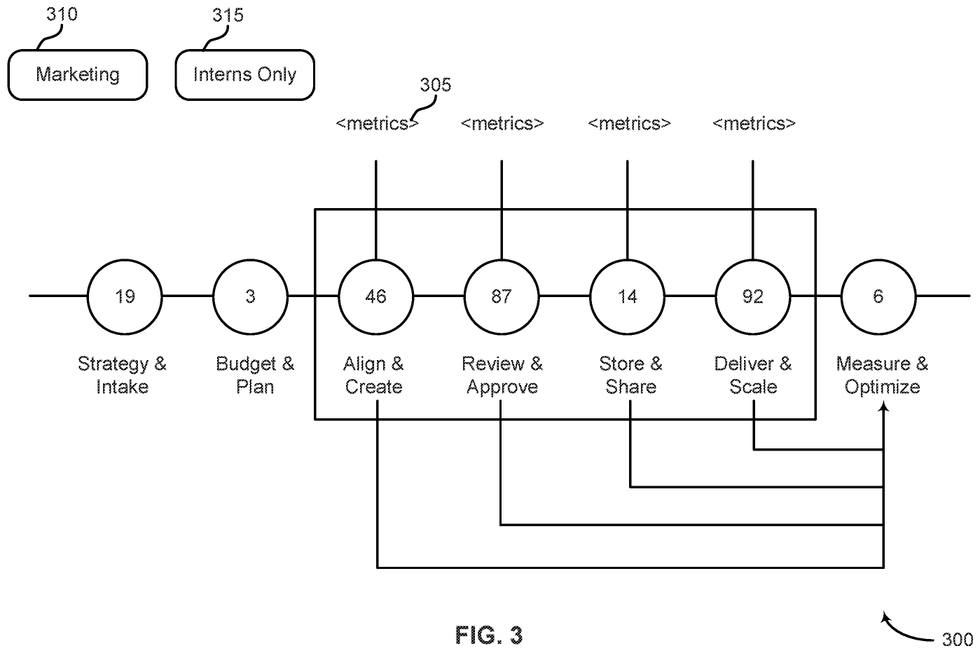

FIG. 3 shows an example of a workflow process in a department of a company according to aspects of the present disclosure. The example shown includes user interface 300, metrics 305, department category 310, and employee category 315. User interface 300 may be implemented on a user device with reference to FIG. 1. According to some embodiments, user interface 300 is configured to display the attribution information and/or the segmentation information. In some examples, a user is able to select from a dropdown box such as department category 310, and employee category 315.

As an example illustrated in FIG. 3, an organization may use the software management apparatus herein to represent work or jobs performed by marketing interns (i.e., narrow down to a certain type of staff members within a department). Here, department category 310 and employee category 315 are the marketing department and interns, respectively. Numbers may represent multiple things. In one example, the numbers may represent a number of interns assigned to a task or work. As the example shown in FIG. 3, 19 interns are assigned to strategy and intake, while 3 interns are assigned to budget and planning. The example includes a workflow starting from strategy and intake task, all the way to measure and optimize task. However, order of the workflow may subject to change.

In an embodiment, the user can select a portion of the steps on the user interface 300 of the software management apparatus to examine further aggregations or metrics. In the example, arrows represent the metrics and emphasize the effect one area had on another area. In this example, align and create task/work have an impact on measure and optimize task. Review and approval task also have an impact on measure and optimize. A user (e.g., software user such as a company executive) clicks on one of the areas and views the current status of work requests.

One or more embodiments of the present disclosure include metrics which are switched out or toggled in numerous places. In some examples, the metrics include number of requests (tasks) at each state, number of resources (headcount) at each state, number of person-hours spent on the current requests at each state, and number of blocked tasks at each state. Additionally, the metrics include request velocity at each state (or overall) above or below benchmarks or goals at each state (or overall), trends over time (compared to last week, last year, etc.). Furthermore, the metrics include custom calculations of customer or employee satisfaction, bottlenecks, innovation scores, etc. Embodiments of the present disclosure are not limited to the above-mentioned metrics.

In some embodiments of the present disclosure, the software management apparatus computes and signals segmentation information. The software management apparatus is configured to compute and show segmentation information including the entire organization or a portion of the organization (e.g., the marketing department). For example, the software management apparatus can be queried to show employees who have been working at the company for 6 months, show remote employees, U.S. East versus U.S. West. etc. Additionally or alternatively, the software management apparatus computes segmentation information that indicates selection and reporting of a part of the states, completed and/or problem tasks, exclusively bottleneck areas, etc.

In an embodiment, the software management apparatus is configured to compute and display attribution information or flow information (e.g., request flows or budget flows). In some cases, request flows may be referred to following a specific task from inception to completion, including spawning of new tasks. By using one or more of the metrics mentioned above, the software management apparatus described herein is able to determine the impact of a task at one state and its impact on other states. Similarly, budget flows show budget allocation and the effect of budget allocation at one state on one or more subsequent states.

### Software Management System Architecture

In FIGS. 4-5, an apparatus and method for software management are described. One or more embodiments of the apparatus and method include a first software system configured to generate first event data formatted using a first data format, a second software system configured to generate second event data formatted using a second data format, a data conversion component configured to generate first converted event data and second converted event data by converting the first event data and the second event data to a common data format, a data combining component configured to generate combined time series data by combining the first converted event data and the second converted event data, and an attribution component configured to compute attribution information indicating a causal relationship between a first metric from the first software system and a second metric from the second software system based on the combined time series data.

Some examples of the apparatus and method further include a segmentation component configured to compute segmentation information based on the combined time series data. Some examples of the apparatus and method further include an anomaly detection component configured to identify an anomaly in the first metric based on the combined time series data. Some examples of the apparatus and method further include a user interface configured to display the attribution information.

FIG. 4 shows an example of a software management apparatus 400 according to aspects of the present disclosure. The example shown includes software management apparatus 400, which includes processor unit 405, memory unit 410, data conversion component 415, data combining component 420, attribution component 425, segmentation component 430, and anomaly detection component 435. Software management apparatus 400 is an example of, or includes aspects of, the corresponding element described with reference to FIG. 1.

A processor unit 405 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor unit 405 is configured to operate a memory array using a memory controller. In other cases, a memory controller is integrated into the processor. In some cases, the processor unit 405 is configured to execute computer-readable instructions stored in a memory to perform various functions. In some embodiments, a processor unit 405 includes special purpose components for modem processing, baseband processing, digital signal processing, or transmission processing.

Examples of a memory unit 410 include random access memory (RAM), read-only memory (ROM), or a hard disk. Examples of memory unit 410 include solid state memory and a hard disk drive. In some examples, a memory unit 410 is used to store computer-readable, computer-executable software including instructions that, when executed, cause a processor to perform various functions described herein. In some cases, the memory unit 410 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory unit 410 store information in the form of a logical state.

According to some embodiments, data conversion component 415 generates first converted event data and second converted event data by converting the first event data and the second event data to a common data format. Data conversion component 415 is an example of, or includes aspects of, the corresponding element described with reference to FIG. 5.

According to some embodiments, data combining component 420 generates combined time series data by combining the first converted event data and the second converted event data. Data combining component 420 is an example of, or includes aspects of, the corresponding element described with reference to FIG. 5.

According to some embodiments, attribution component 425 computes attribution information indicating a causal relationship between a first metric from the first software system and a second metric from the second software system based on the combined time series data. In some examples, the first metric and the second metric include elements from a list including a number of tasks, a number of completed tasks, a number of incomplete tasks, a request velocity, an amount of resources, an amount of money, a number of person-hours, an employee satisfaction metric, a customer satisfaction metric, a customer conversion metric, a task duration, or any combination thereof. Attribution component 425 is an example of, or includes aspects of, the corresponding element described with reference to FIG. 5.

According to some embodiments, segmentation component 430 computes segmentation information based on the combined time series data. In some examples, the segmentation information segments employees, customers, tasks, or any combination thereof. In some examples, the segmentation information is based on geography, organization department, time frame, demographic information, or any combination thereof.

According to some embodiments, segmentation component 430 computes segmentation information indicating a set of data groups based on the combined time series data. Segmentation component 430 is an example of, or includes aspects of, the corresponding element described with reference to FIG. 5.

According to some embodiments, anomaly detection component 435 is configured to identify an anomaly in the first metric based on the combined time series data. Anomaly detection component 435 is an example of, or includes aspects of, the corresponding element described with reference to FIG. 5.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

FIG. 5 shows an example of a software management apparatus according to aspects of the present disclosure. The example shown includes first software system 500, second software system 505, data conversion component 510, data combining component 515, attribution component 520, segmentation component 525, and anomaly detection component 530.

In some examples, the first software system 500 is associated with a first department of an organization and the second software system 505 is associated with a second department of the organization. The first software system 500 does not produce data in the second data format. In some examples, the first software system 500 includes one of a list including a human resources system, a project management system, a code tracking system, an intellectual property tracking system, a marketing system, a customer relationship management system, and an accounting system. In some examples, the first event data and the second event data include task creation data, task state change data, task completion data, or any combination thereof. In some examples, the second software system 505 includes another from the list different from the first software system 500.

According to some embodiments, first software system 500 is configured to generate first event data formatted using a first data format. Second software system 505 is configured to generate second event data formatted using a second data format.

As illustrated in FIG. 5, first software system 500 generates first event data. Second software system 505 generates second event data. The first event data and the second event data are then input to data conversion component 510. Data conversion component 510 is an example of, or includes aspects of, the corresponding element described with reference to FIG. 4. Data conversion component 510 converts the first event data and outputs first converted event data. Data conversion component 510 converts the second event data and outputs second converted event data. The first converted event data and the second converted event data share a common data format. Subsequently, the first converted event data and the second converted event data are input to data combining component 515. Data combining component 515 combines the first converted event data and the second converted event data and outputs combined time series data. Data combining component 515 is an example of, or includes aspects of, the corresponding element described with reference to FIG. 4.

In an embodiment, the combined time series data is then input to attribution component 520. Attribution component 520 computes attribution information indicating a causal relationship between a first metric from the first software system 500 and a second metric from the second software system 505 based on the combined time series data. Attribution component 520 is an example of, or includes aspects of, the corresponding element described with reference to FIG. 4.

Segmentation component 525 computes segmentation information indicating a set of data groups based on the combined time series data. Segmentation component 525 is an example of, or includes aspects of, the corresponding element described with reference to FIG. 4.

Anomaly detection component 530 is configured to identify one or more anomalies and flag one or more metrics (example metrics are described in FIG. 3) when the metrics are anomalous at any state (e.g., at any stage of a workflow or a software management process). Anomaly detection component 530 is an example of, or includes aspects of, the corresponding element described with reference to FIG. 4.

### Computing Attribution Information

In FIG. 6, a method, apparatus, and non-transitory computer readable medium for software management are described. One or more embodiments of the method, apparatus, and non-transitory computer readable medium include receiving first event data from a first software system and second event data from a second software system, wherein the first event data is formatted using a first data format and the second event data is formatted using a second data format, generating first converted event data and second converted event data by converting the first event data and the second event data to a common data format, generating combined time series data by combining the first converted event data and the second converted event data, computing attribution information indicating a causal relationship between a first metric from the first software system and a second metric from the second software system based on the combined time series data, and signaling the attribution information indicating the relationship between the first metric and the second metric (e.g., electronically transmitting the attribution information).

Some examples of the method, apparatus, and non-transitory computer readable medium further include computing segmentation information based on the combined time series data. In some examples, the segmentation information segments employees, customers, tasks, or any combination thereof. In some examples, the segmentation information is based on geography, organization department, time frame, demographic information, or any combination thereof.

In some examples, the first software system is associated with a first department of an organization and the second software system is associated with a second department of the organization. In some examples, the first software system does not produce data in the second data format. In some examples, the first software system comprises one of a list comprising a human resources system, a project management system, a code tracking system, an intellectual property tracking system, a marketing system, a customer relationship management system, and an accounting system. In some examples, the second software system comprises another from the list different from the first software system.

In some examples, the first metric and the second metric comprise elements from a list comprising a number of tasks, a number of completed tasks, a number of incomplete tasks, a request velocity, an amount of resources, an amount of money, a number of person-hours, an employee satisfaction metric, a customer satisfaction metric, a customer conversion metric, a task duration, or any combination thereof.

Some examples of the method, apparatus, and non-transitory computer readable medium further include identifying an anomaly in the first metric based on the combined time series data. In some examples, the first event data and the second event data comprise task creation data, task state change data, task completion data, or any combination thereof. Some examples of the method, apparatus, and non-transitory computer readable medium further include displaying the attribution information via a user interface.

FIG. 6 shows an example of a process for computing attribution information according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 600, the system receives first event data from a first software system and second event data from a second software system, where the first event data is formatted using a first data format and the second event data is formatted using a second data format. In some cases, the operations of this step refer to, or may be performed by, a software management apparatus as described with reference to FIGS. 1 and 4.

At operation 605, the system generates first converted event data and second converted event data by converting the first event data and the second event data to a common data format. The event data can be converted to the common data format by converting field names, removing fields, or adding new fields. In some cases, the values for new fields can be computed based on multiple existing fields. In some cases, the operations of this step refer to, or may be performed by, a data conversion component as described with reference to FIGS. 4 and 5.

In some embodiments, the system receives multiple events coming from multiple different software systems that would further be normalized into a common data format. The system or the user creates a data schema that indicates a list of properties that may be populated (some properties may be required while some may be optional). Each property is associated with a data type as well (such as string, int, etc.). Each event (which contains multiple properties itself) from each software system is mapped into these properties of the final, normalized data schema using the software management apparatus herein. An optional set of rules may be applied on a per-system basis, which perform small ETL operations, as well as any property name mapping conversions. Any non-relevant property from the incoming event that is not serialized into the normalized schema are discarded.

For example, first event data having a first data format can have fields labeled “First Name”, “Last Name”, “Transaction Type”, “Date”, and “Amount”, whereas second event data can have a second data format with fields labeled “Client”, “Issue”, “Time Reported”, “Time Resolved”, “Owner”. Both the first data and the second data can be converted to a common data format with fields labeled “Organization”, “Time Initiated”, “Time Completed”, “Category”, and “Contact”. An algorithm for converting the first data to the common format can be different from an algorithm for converting the second data into the common format. In some cases, the algorithms can use information meta-data that is not in the data itself. For example, the “Organization” field may be inferred based on the source of the data rather than information in the data itself.

At operation 610, the system generates combined time series data by combining the first converted event data and the second converted event data. In some cases, the operations of this step refer to, or may be performed by, a data combining component as described with reference to FIGS. 4 and 5.

At operation 615, the system computes attribution information indicating a causal relationship between a first metric from the first software system and a second metric from the second software system based on the combined time series data. In some cases, the operations of this step refer to, or may be performed by, an attribution component as described with reference to FIGS. 4 and 5.

In an embodiment, when the data is all serialized in a normalized data format across input software systems, a user can execute analytical queries against the system to determine attribution relationships. Data is stored or indexed on a per-person basis (via a common person id in the normalized data schema). When a query is submitted to the system to determine if metric A influences metric B, the system or the software management apparatus traverses through all the events (sequenced in time-series order) for each person identified in the normalized system and looks for instances of the metric A leading up to the metric B. An attribution algorithm specified in the query is applied to calculate the results for that person, such as first-touch, last-touch, time-decay, etc. Then all results for all people are aggregated and returned to the user (e.g., the caller).

At operation 620, the system signals the attribution information indicating the relationship between the first metric and the second metric. In some cases, the operations of this step refer to, or may be performed by, a software management apparatus as described with reference to FIGS. 1 and 4.

In some embodiments of the present disclosure, the system tracks and measures pieces of work performed as tasks or requests (including accompanying state, attributes, metadata, etc.). The system is configured to record work request state changes, subsequent task creation, and task completion. These data recorded are then stored in a database or a data store, for example, a columnar database for fast retrieval across multiple columns. In some examples, a user may enter queries from a user interface (UI) to filter and aggregate in real-time, and display the data and results in the user interface. The user interface may be implemented on a user device with reference to FIG. 1.

In some embodiments, the system displays an integrated, dynamic view to users (e.g., business executives). The integrated view can be used by customers (e.g., customers using Adobe® Workfront). The integrated view increases the performance of analytics applications such as Adobe® Experience Cloud and leads to increased analytics performance on platforms.

### Computing Segmentation Information

In FIG. 7, a method, apparatus, and non-transitory computer readable medium for software management are described. One or more embodiments of the method, apparatus, and non-transitory computer readable medium include receiving first event data from a first software system and second event data from a second software system, wherein the first event data is formatted using a first data format and the second event data is formatted using a second data format, generating first converted event data and second converted event data by converting the first event data and the second event data to a common data format, generating combined time series data by combining the first converted event data and the second converted event data, computing segmentation information indicating a plurality of data groups based on the combined time series data, and signaling the segmentation information indicating the plurality of data groups.

Some examples of the method, apparatus, and non-transitory computer readable medium further include computing attribution information indicating a causal relationship between a first metric from the first software system and a second metric from the second software system based on the combined time series data. For example, a causal relationship may indicate that an increase in the time it takes for issues to be resolved in a customer service department is causally related to (i.e., a cause of) a decrease in customer retention numbers measured by another department of an organization.

In some examples, the segmentation information segments employees, customers, tasks, or any combination thereof. In some examples, the segmentation information is based on geography, organization department, time frame, demographic information, or any combination thereof.

FIG. 7 shows an example of a process of computing segmentation information according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 700, the system receives first event data from a first software system and second event data from a second software system, where the first event data is formatted using a first data format and the second event data is formatted using a second data format. In some cases, the operations of this step refer to, or may be performed by, a software management apparatus as described with reference to FIGS. 1 and 4.

At operation 705, the system generates first converted event data and second converted event data by converting the first event data and the second event data to a common data format. In some cases, the operations of this step refer to, or may be performed by, a data conversion component as described with reference to FIGS. 4 and 5.

At operation 710, the system generates combined time series data by combining the first converted event data and the second converted event data. In some cases, the operations of this step refer to, or may be performed by, a data combining component as described with reference to FIGS. 4 and 5.

At operation 715, the system computes segmentation information indicating a set of data groups based on the combined time series data. In some cases, the operations of this step refer to, or may be performed by, a segmentation component as described with reference to FIGS. 4 and 5.

In an embodiment, when the data is all serialized in a normalized data format across input software systems, a user can execute analytical queries against the system with specific segmentation commands (e.g., segmentation requirements). These segmentation requirements reference any property in the normalized schema, which may contain data across multiple software systems. Segmentation requirements can be grouped using Boolean logic operators (AND, OR), as well as sequential logic operators (THEN), and each requirement can be executed at the individual event level, or individual person level. When a query is submitted to the system to segment down to the people who had property X=1 and then Y=2 sometime later, the system traverses through all events for each person and makes sure they have X=1 before Y=2. And if so, all the events corresponding to that person are included and returned to the user (e.g., caller).

At operation 720, the system signals the segmentation information indicating the set of data groups. In some cases, the operations of this step refer to, or may be performed by, a software management apparatus as described with reference to FIGS. 1 and 4.

In some examples, a company workflow system (e.g., Adobe® Workfront) may be integrated with analytics systems such as Adobe® Experience Platform (AEP) for subsequent segmentation, attribution, anomaly detection, etc. The software management apparatus herein provides users with a company macro-level view. Additionally, the dynamic, analytical user interface presents a complete view of how work is performed inside the company (e.g., from creation of the work to the completion of the work). The system includes filtering or drill-in capabilities where users (e.g., business executives) can understand the influence of one section of the company on another. For example, users can analyze the influence of marketing department of the company on the other departments.

Software management apparatus and systems of the present disclosure outperform existing workflow and project management software. The software management apparatus includes a common system of tracking multiple types of work (and is customizable) across an entire company. Conventional systems track items in disparate systems such as email, spreadsheets. Existing systems are not able to show work progress and influence of the work progress across the entire company. Some embodiments of the present disclosure can analyze and present the impact of one task from department A on another task from department B or the company as a whole. The software management apparatus described herein offers a broad and general view and users are able to filter down to parts of interest using an attribution component and a segmentation component.

Embodiments of the present disclosure enable improved resource allocation. For example, in addition to event data, embodiments of the disclosure take resource allocation data (i.e., a proposed budget or a proposed allocation of manpower) and predicts business metrics.

Thus, in an embodiment, a method includes receiving first event data from a first software system used by a first organizational unit and second event data from a second software system used by a second organizational unit, where the first event data is formatted using a first data format and the second event data is formatted using a second data format, generating first converted event data and second converted event data by converting the first event data and the second event data to a common data format, generating a model for predicting an organizational metric based on the first converted event data and the second converted event data, receiving a candidate resource allocation that includes resources for the first organizational unit and the second organizational unit, and predicting an outcome for the first metric based on the model and the candidate resource allocation.

In some cases, company leadership wants to know how and where to allocate company resources (e.g., time, money, etc.) and wants to know the return on investment (ROI) in the areas. Existing software systems may provide prediction or optimization for a given data silo, which may then be applied in the context of financial markets and search engine keywords. However, conventional software management systems fail to track work performed across an entire business entity or evaluate the impact of the work in one area on the output of another area of the business entity. One or more embodiments of the present disclosure include a software management apparatus having attribution and measurement capabilities across an organization. In some examples, company leadership may set goals for results, and machine learning techniques may be used to predict return on investment and recommend changes across the organization. Non-obvious relationships among disparate departments may be mined, discovered, and presented. Some examples include the impact of having a university partner program on customer satisfaction scores, or on-site food orders on partner retention, etc.

Conventional systems perform these tasks at a micro-level and not in a data-driven manner Companies evaluate the work done in different departments arbitrarily through meetings, emails, and spreadsheets. One or more embodiments of the present disclosure are able to carry out macro-level optimization and evaluate relationship between disparate departments within a company using data-driven methods.

In some embodiments of the present disclosure, a user interface is used by users (e.g., business executives) to analyze how the change to one task or request usage parameter or configuration may affect efficiencies and performance of other unrelated departments in the same company. For example, the software management system including the user interface may be used where a company executive drags sliders around in a budget allocation view and see the predicted effect on customer satisfaction scores, display ad quality scores, employee satisfaction, etc. In some examples, the slider metrics for predictions are the number of stocks to release, number of patents to file, name of vendor to use, etc.

In an embodiment, each piece of work performed is encapsulated in a task or request with metadata (e.g., one type of metadata is department). The software management system tracks the pieces of work in a database (e.g., timeline for assignment of a piece of work, or completion of the piece of work, amount of resources devoted to the piece of work, etc.). The user can choose the inputs and outputs (and any filters, e.g., view employees located in U.S. East only) based on work tasks or requests. The inputs and outputs are then used as input features by a machine learning network. The machine learning network predicts, when one type of work task parameter or configuration changes, how the change may affect another work task.

In some embodiments, the software management apparatus automatically generates recommendations on where changes should be made to obtain the most lift or value based on user-specified or system-recommended goals and objectives. A user (e.g., a customer) specifies metrics based on work tasks or requests, and/or any associated parameters or configurations that the user is interested in. The software management apparatus can recommend a set of output metrics based on existing customer usage for the user to choose from. Similarly, the software management apparatus can recommend input metrics based on customer usage for the user to choose from. In some examples, the apparatus offers an option try a random sample. The machine learning network can run predictions at a given interval (for example, once a day) to automatically provide insights that are above or below a given threshold which is hard-coded or set by the user (e.g., a customer). As a result, the software management apparatus automatically showcases the changes that give the user/customer the highest return on investment and discover any non-obvious relationships between departments, etc.

In some cases, companies face the task of determining the number of resources to hire and where to put the resources in the company (i.e., allocated to which department in the company). In some examples, the hiring of resources is a trickle-up aggregation request (i.e., the number of resources needed by directs or sub-departments in a department) combined with a trickle-down company-wide compromise. For example, one department head of a company places an original request for 24 new hires. The department head finally receives 9 new hires, thus, each direct or sub-department has 3 new hires. Each level attempts to justify the requested resources (e.g., an addition of two engineers can deliver X, etc.). However, conventional systems are not able to compare the incremental value of a resource in one department to that of another department. Embodiments of the present disclosure can compare average resource in disparate departments (e.g., accounting, sales, and engineering) and predict how changes to resource pools may affect overall company goals. As a result, the software management apparatus enables CEO of a company to assign resources at a small team level (e.g., engineering quality assurance team) based on predicted impact to the business and company goals (i.e., the predicted impact of allocating a certain amount of resource to one team or one department on another team, another department, or the company as a whole).

In some examples, the software management apparatus can assist business leadership in deciding which employees should receive stock, investment in a given vendor type, investment in the patent process, how many days off employees take, etc. and the influence of each of these decisions on other parts of the business.

One or more embodiments of the present disclosure include a software management apparatus capable of interactive prediction and optimization across the entire organization (e.g., resource allocation at macro-level). The software management apparatus predicts the effect of an action in one area of the business on another area of the business with customer input. In some cases, the software management apparatus can generate recommendations regarding actions or changes to make in various parts of the business, based on task flow throughout the entire work ecosystem.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for software management, comprising:
receiving first event data from a first software system and second event data from a second software system, wherein the first event data is formatted using a first data format and the second event data is formatted using a second data format;
generating first converted event data and second converted event data by converting the first event data and the second event data to a common data format;
generating combined time series data by combining the first converted event data and the second converted event data;
computing attribution information indicating a causal relationship between a first metric from the first software system and a second metric from the second software system based on the combined time series data; and
signaling the attribution information indicating the relationship between the first metric and the second metric.

2. The method of claim 1, further comprising:
computing segmentation information based on the combined time series data.

3. The method of claim 2, wherein:
the segmentation information segments employees, customers, tasks, or any combination thereof.

4. The method of claim 2, wherein:
the segmentation information is based on geography, organization department, time frame, demographic information, or any combination thereof.

5. The method of claim 1, wherein:
the first software system is associated with a first department of an organization and the second software system is associated with a second department of the organization.

6. The method of claim 1, wherein:
the first software system does not produce data in the second data format.

7. The method of claim 1, wherein:
the first software system comprises one of a list comprising a human resources system, a project management system, a code tracking system, an intellectual property tracking system, a marketing system, a customer relationship management system, and an accounting system.

8. The method of claim 7, wherein:
the second software system comprises another from the list different from the first software system.

9. The method of claim 1, wherein:
the first metric and the second metric comprise elements from a list comprising a number of tasks, a number of completed tasks, a number of incomplete tasks, a request velocity, an amount of resources, an amount of money, a number of person-hours, an employee satisfaction metric, a customer satisfaction metric, a customer conversion metric, a task duration, or any combination thereof.

10. The method of claim 1, further comprising:
identifying an anomaly in the first metric based on the combined time series data.

11. The method of claim 1, wherein:
the first event data and the second event data comprise task creation data, task state change data, task completion data, or any combination thereof.

12. The method of claim 1, further comprising:
displaying the attribution information via a user interface.

13. A method for software management, comprising:
receiving first event data from a first software system and second event data from a second software system, wherein the first event data is formatted using a first data format and the second event data is formatted using a second data format;
generating first converted event data and second converted event data by converting the first event data and the second event data to a common data format;
generating combined time series data by combining the first converted event data and the second converted event data;
computing segmentation information indicating a plurality of data groups based on the combined time series data; and
signaling the segmentation information indicating the plurality of data groups.

14. The method of claim 13, further comprising:
computing attribution information indicating a causal relationship between a first metric from the first software system and a second metric from the second software system based on the combined time series data.

15. The method of claim 13, wherein:
the segmentation information segments employees, customers, tasks, or any combination thereof.

16. The method of claim 13, wherein:
the segmentation information is based on geography, organization department, time frame, demographic information, or any combination thereof.

17. An apparatus for software management, comprising:
a first software system configured to generate first event data formatted using a first data format;
a second software system configured to generate second event data formatted using a second data format;
a data conversion component configured to generate first converted event data and second converted event data by converting the first event data and the second event data to a common data format;
a data combining component configured to generate combined time series data by combining the first converted event data and the second converted event data; and
an attribution component configured to compute attribution information indicating a causal relationship between a first metric from the first software system and a second metric from the second software system based on the combined time series data.

18. The apparatus of claim 17, further comprising:
a segmentation component configured to compute segmentation information based on the combined time series data.

19. The apparatus of claim 17, further comprising:
an anomaly detection component configured to identify an anomaly in the first metric based on the combined time series data.

20. The apparatus of claim 17, further comprising:
a user interface configured to display the attribution information.
